(19) United States
(12) Patent Application Publication
(10) Pub. No.: US 2011/0187016 A1
(43) Pub. Date: Aug. 4, 2011

(54) RAPID LOW-COST MANUFACTURE OF TABLETS USING DISPOSABLE EQUIPMENT

(76) Inventor: Kim Gary Gulliver, Swindon (GB)

(21) Appl. No.: 13/056,007

(22) PCT Filed: Aug. 5, 2009
(86) PCT No.: PCT/GB2009/001927

§ 371 Date: Apr. 18, 2011

(30) Foreign Application Priority Data
Aug. 6, 2008 (GB) 0814437.0

(51) Int. Cl. B28B 3/02

(52) U.S. Cl. 264/109; 425/411

(57) ABSTRACT

A tablet-pressing apparatus comprising i) a hopper (10), ii) a tablet-pressing table (20) in which there is provided a die (30) for containing material that is to be pressed into a tablet, and iii) a punch (40) for pressing material in the die (30) to form a tablet is described. The components (10, 24, 30, 40, 42, 50) of the apparatus that come into contact with the material or the tablets may be disposable and thus readily replaced at low-cost. For example, the table (20) may comprise a removable top plate (24) so that after the tablet-pressing apparatus has been used to produce a batch of tablets, the top plate (24) may be disposed of and replaced with a fresh top plate. The apparatus may then be used to press a batch of tablets of a different composition without needing to clean the top of the table (20).

The present invention concerns the manufacture of tablets and apparatus for performing such manufacture.

### BACKGROUND OF THE INVENTION

Tablets can be manufactured by means of a tablet press. A tablet press can be used to manufacture batches of tablets of differing compositions, in which case the press must be cleaned between manufacturing successive batches of tablets of differing compositions. Moreover, all parts of the press which contact product during manufacture must be clean and free of potential contaminants to a very high level before a new batch of tablets can be manufactured. Such a requirement typically results in time-consuming cleaning operations being carried out before equipment can be reused to manufacture a batch of tablets having a composition different from the previous batch. Typically, equipment must be properly verified as sufficiently clean before the equipment can be reused. The time needed to perform such cleaning and verification operations can make the production of a small batch of tablets relatively expensive. It is desirable to reduce equipment downtime, such as when the tablet-pressing equipment is out of use as a result of being the subject of the cleaning and verification process.

U.S. Pat. No. 6,676,863 describes a rotary tablet press comprising a detachably mounted compression unit having a rotary die table, punches, a material-feeding device, and a tablet discharge device. Dies are arranged circumferentially in the die table, and each die is associated with two punches for compressing tablets. The compression unit encloses each die opening and the corresponding punches in a chamber. The feeding device and the tablet discharge device are also enclosed. By means of enclosing both the area around the die where the tablets are compressed and the feeding and discharge devices, it is possible to keep the product always confined in the detachable compression unit. The compression unit is arranged to be exchangeable for another compression unit so that between success different batches of tablets the compression unit can simply be replaced with a clean compression unit. Other parts of the tablet press can be cleaned in accordance with known techniques. The used compression unit can be cleaned whilst the new compression unit is used to press the next batch of tablets, thereby reducing down-time. Connections between the compression unit and the tablet press housing can be in the form of split butterfly valves or in the form of disposable plastic tubes that are cut into two before disengagement of the compression unit from the press housing.

Whilst the proposal described in U.S. Pat. No. 6,676,863 may be able to reduce down-time, there is still a need to clean the compression unit before it can be reused. Thus, the man-hours spent in manufacturing a batch of tablets is not reduced by means of the provision of a removable compression unit, because a compression unit needs to be cleaned, and verified as clean, in the conventional way before a new batch of tablets, of a different composition, is pressed.

The present invention seeks to mitigate the above-mentioned problems. Alternatively or additionally, the present invention seeks to provide an improved tablet-pressing apparatus or method, preferably in a form that facilitates rapid low-cost manufacture of tablets.

### SUMMARY OF THE INVENTION

The present invention provides, according to a first aspect, a method of pressing two consecutive batches of tablets comprising steps as set out in claim 1. Embodiments of the method of claim 1 enable rapid low-cost manufacture of tablets using disposable equipment. In particular, the provision of a removable and disposable upper surface of the table, is an innovation that allows tablets to be made with apparatus having product-contact parts that are all disposable, which is not made possible with prior art tablet-pressing tables which can not be considered as disposable.

A second aspect of the invention provides a tablet-pressing apparatus as claimed in claim 10. As a result of the top plate being removably mounted, the top plate may be disposed of and replaced with a fresh top plate, after the tablet-pressing apparatus has been used to produce a batch of tablets. The tablet-pressing apparatus may then be used to press a batch of tablets of a different composition without needing to clean the top of the table. Thus, the top plate may be removably mounted so that after the tablet-pressing apparatus has been used to produce a batch of tablets, the top plate may be disposed of and replaced with a fresh top plate so that the tablet-pressing apparatus may then be used to press a batch of tablets of a different composition without needing to clean the top of the table.

The present invention yet further provides, according to a third aspect, a tablet-pressing table as claimed in claim 17. Preferred (but optional) features of the invention are set out in the dependent claims.

It will be appreciated that aspects of the present invention described in relation to the apparatus of the present invention are equally applicable to the method of the present invention and vice versa.

### DESCRIPTION OF THE DRAWINGS

Embodiments of the present invention will now be described by way of example only with reference to the accompanying schematic drawings of which:

FIG. 1 shows a sectional side view of a tablet press according to a first embodiment of the invention;

FIG. 2 shows a sectional side view of a partly dissembled table of the tablet press of FIG. 1; and

FIG. 3 shows a sectional side view of an assembled table of the tablet press of FIG. 1.

### DETAILED DESCRIPTION

Pharmaceutical products manufactured with non-dedicated equipment are at risk of being contaminated with traces of the previous product manufactured. This risk is typically reduced by strict equipment cleaning regimes and cleaning verification/validation programs. These can be costly, time consuming and can only ever reduce the risk of contamination, not remove it completely.

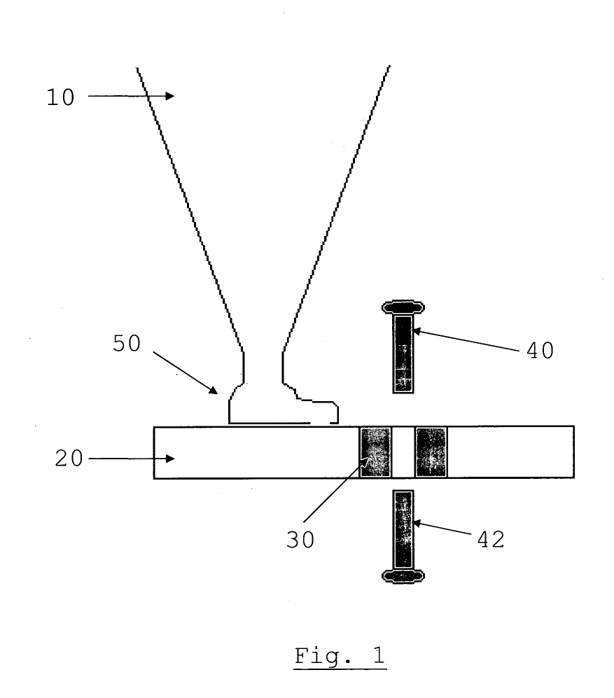

The embodiment of the present invention, illustrated by FIGS. 1 to 3, concerns a single-punch tablet press in which those parts that contact product (the material from which the tablets are pressed or the tablets once pressed) are disposable. This has the benefit of reducing set-up/clean-down times and removes the need for expensive cleaning verification and validation processes.

There are three distinct processes required to make tablets in accordance with the first embodiment. These processes are (1) dispensing of ingredients, (2) blending of ingredients and (3) compression of powder blend into tablets. The blending of ingredients during step (2) can be a simple blending operation, or granules can be prepared. In accordance with this embodiment of the invention, all parts that contact product during the three processes are disposable and not therefore reused with product having a different composition.

When dispensing ingredients, the equipment that is typically used comprises a balance, scoops/spatulas and containers for the ingredients. The balance does not contact product directly and does not need to be considered. Scoops and spatulas do however contact product directly, but can be disposed of and replaced with new scoops/spatulas if and when difference ingredients need to be handled. Preferably, such items are made of plastics material. Containers for the ingredients are typically plastic bags or pots which are already considered to be disposable.

Blending of the ingredients is conveniently carried out by tumble blending. The powders are placed in a suitably sized container which is then rotated at a set speed for a defined period of time. Only the container is considered to be a product contact part. A removable container is used and is disposed of after use. There are several manufacturers of tumbling mixer drive units readily available on the market compatible with the use of such a removable container.

Granulation of the powder can be achieved within a simple rotary blender similar to a traditional food blender. The granulation liquid is added to the powder being granulated to form a mass of material which is then passed through a screen. The mixing bowl and mixing head are the only product contact parts and can be disposed of. The screened material would then need to be dried in a fluid bed dryer. The bowl and filter of the dryer can are the only product contact parts and can be disposed of.

Compression of powder blend into tablets is performed by means of using a tablet press as shown in FIG. 1. The press may be in the form of a single punch tablet press such as for example to a Manesty F3 press, which is a relatively simple, single punch tablet press. Differences in design and function as between a standard single punch press and the press of the embodiment of the invention are described below.

The tablet press comprises a powder storage device, in the form of a hopper 10, for receiving the powder blend, a tablet-pressing table 20 in which there is provided a die 30, and a pair of punches 40, 42 for pressing material in the die to form a tablet. The press includes a shoe 50 for delivering powder from the hopper 10 to the die 30. Each part of the press that contacts the product is disposable, as explained in further detail below.

The hopper 10, which holds the powder blend to be delivered to the shoe 50, would normally be made of a durable material such as stainless steel. In accordance with the embodiment of the present invention the hopper is made of a plastics material, which although of less durable material is still considered acceptable from pharmaceutical quality perspective.

The shoe 50, which delivers the powder blend to the die 30, is made of metal but is a sufficiently simple part that it can be considered as disposable, relative to the cost of cleaning the shoe and conducting cleaning verification.

The die 30, top punch 40 and bottom punch 42 are purchased as a set. It is in the die 30 that the tablet is formed by compressing the powder blend between the two punches 40, 42. A set of die and punches are made of metal but are, in a similar manner to the shoe 50, of sufficiently simple construction that they can be considered as disposable, relative to the cost of cleaning the shoe and conducting cleaning verification.

The table of a conventional single punch press is an integral part of the tablet press machine and is a product contact part. It is typically made from a large, heavy piece of stainless steel or cast iron, and is relatively expensive to replace. The table, if replaced, must be set up by a skilled technician to ensure correct alignment with the other parts of the press. In a conventional single punch press, the table is not therefore readily changed/removed and would not be considered as disposable or as a single-use, quick-to-replace, part.

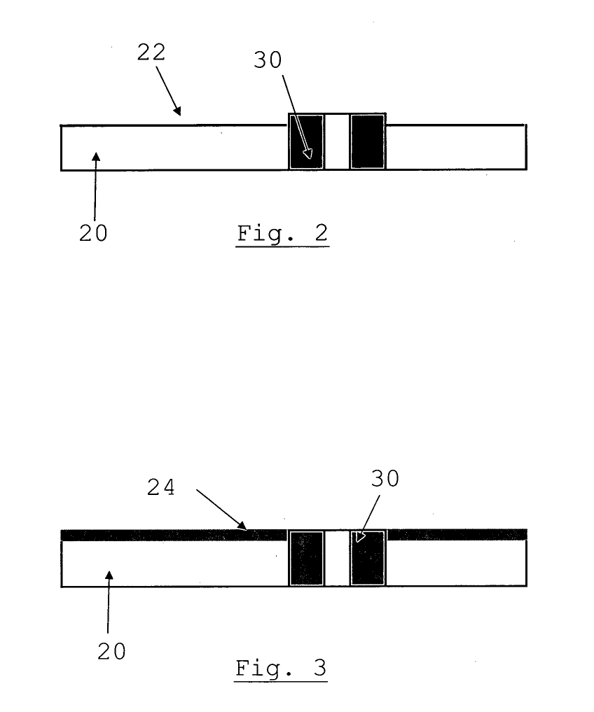

The table 20 of the embodiment of the present invention is shown in further detail in FIGS. 2 and 3. FIG. 3 shows the table with a removable top plate 24 in place, whereas FIG. 2 shows the table without its top plate. The table 20 is similar to the table of the conventional press, but, as shown in FIG. 2, has an upper surface 22 that has been skimmed by about 3 mm. As can be seen in FIG. 2, the die 30 thus stands proud of the table by about 3 mm. The top plate 24 shown in FIG. 3 assembled with the table 20 has an upper surface which encompasses all regions of product contact. The top plate is made from a 3 mm sheet of stainless steel and is cut to the same outline shape as the table 20. The top plate 24 is fitted to the top surface 22 of the table 20 with screws (not shown) and is located in correct alignment with the table 20 by means of locating spigots (not shown) which engage with corresponding recesses (not shown) in the table 20.

After the tablet-pressing apparatus has been used to produce a batch of tablets, the top plate 24 being removably mounted and of simple construction, may be disposed of and replaced with a fresh top plate (for example, a new or clean top plate) so that the tablet-pressing apparatus may then be used to press a batch of tablets of a different composition without needing to clean the top of the table.

A method of using the tablet-pressing apparatus of the illustrated embodiment will now be described. Ingredients for a first batch of tablets are dispensed and blended using disposable product-contact parts. The resulting powder blend is placed in the hopper 10 of the tablet press. The powder material flows into the shoe 50. The shoe 50 slides across the table 20 until it is above the hole defined by the tablet die 30. Powder then falls into the die 30 and rests on the lower punch 42, which at this stage is accommodated within the die 30. The shoe 50 slides away and the upper and lower punches 40, 42 move together in the die 30 to compress the material in the die 30, thereby forming a tablet. The lower punch 42 moves up the die to expel the tablet as the upper punch 40 moves upwards out of the way. The shoe 50 then slides across the table 20 again nudging the tablet across the table as the shoe 50 moves above the tablet die 30 again to refill the die 30 with powder, to start the tablet-pressing process again. The process is repeated the required number of times to produce the desired number of tablets in the batch.

The equipment is then used to produce a second batch of tablets from material of a different composition from that of the first batch. The equipment needs however to be verified as sufficiently clean of contaminants (for example traces of the material used to make the first batch of tablets) before pressing of tablets in the second batch can be commenced. Parts of the equipment not considered to be product contact parts are wiped down and superficially cleaned. The hopper 10 and shoe 50 are disposed of and replaced with a new hopper and shoe. The top plate 24 of the table 20 is unscrewed, removed and disposed of. The previous set of die and punches are disposed of and replaced with new die and punches. A new top plate is then installed on the table. The table is not moved during this process and as such it is not necessary to adjust or check the alignment of the table relative to the rest of the tablet-pressing apparatus. Thus, the table may be in an alignment relative to the rest of the tablet-pressing apparatus during the production of the first batch of tablets and the table may then be in the same alignment relative to the rest of the tablet-pressing apparatus during the production of the second batch of tablets. The equipment is then subjected to a cleaning-verification test, as is standard and known in the art.

Ingredients for a second batch of tablets are then dispensed and blended using fresh disposable product-contact parts. The resulting powder blend is then placed in the new hopper 10 of the tablet press and a new batch of tablets is then produced in substantially the same manner as the first batch.

As a result of using disposable product contact parts, there is no need to clean such product contact parts in order for such parts to be reused at a later time. It has been found that the costs of establishing a cleaning regime and then carrying out that cleaning regime on product-contact parts is typically more expensive than the cost of replacing the parts as used in the presently described embodiment. Thus, the apparatus of the present embodiment facilitates rapid low-cost manufacture of tablets by reducing the required amount of cleaning of parts of the tablet press before tablet-pressing can be commenced.

Whilst the present invention has been described and illustrated with reference to a particular embodiment, it will be appreciated by those of ordinary skill in the art that the invention lends itself to many different variations not specifically illustrated herein. By way of example only, certain possible variations will now be described.

Rather than providing a plastic hopper, a metal hopper can be provided with a disposable lining, for example a plastic lining. Furthermore, the means of storing powder for delivery to the die need not be in the form of a hopper and may instead be in the form of any suitable material storage device. For example, the material storage device may comprise a reservoir of material, for example held within a container, and a delivery conduit, in the form of for example a chute.

The removable top plate may have a thickness different from 3 mm. The thickness is preferably greater than 0.1 mm and may for example be greater than 0.5 mm. The thickness is preferably less than 25 mm and may for example be less than 10 mm. The removable top plate may be made of plastics material. In such a case, it may be necessary to make the shoe of a material that is sufficiently non-abrasive (but hard enough not to itself be abraded) to ensure that relative movement between the shoe and the top plate does not result in material being scraped from the shoe or table that might contaminate the powder material for forming the tablets. For example, the shoe may be made from the same material as the top plate. The shoe may be made from plastics material.

The concepts embodied by the present invention may be applied to a rotary press, and to a rotary press that simultaneously presses multiple tablets. In such a press, there would of course be multiple dies and multiple punches.

The above described method includes making a first batch of tablets and then using different product-contact parts to make a second batch of tablets of a different composition form the first batch. The product-contact parts used to make the first batch of tablets are preferably disposed of and not reused. Thus, the method may include using, preferably new and disposable, product-contact parts to make a third batch of tablets, the product-contact parts being different from those used in both the first and second batches of tablets. Preferably, fresh product-contact parts (for example, at least the hopper, or lining thereof, the upper surface of the table, and the punch and die set) are used in each of a succession of at least five different batches of tablets.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1-17. (canceled)

18. A method of pressing two consecutive batches of tablets, the method comprising the steps of:
a) providing a tablet-pressing apparatus comprising:
i) a tablet-pressing table in which there is provided a die, and
ii) a punch,
b) feeding material of a first composition to the die,
c) compressing material in the die by means of the punch to form a tablet,
d) expelling the tablet from the die,
e) repeating steps b) and d) to produce a multiplicity of tablets in a first batch from material of the first composition,
f) removing and disposing of an upper surface of the table, and then installing a fresh upper surface on the same table,
g) removing and replacing the punch and the die,
h) feeding material of a second composition, different from the first composition to the die,
i) compressing material in the die by means of the punch to form a tablet,
j) expelling the tablet from the die, and
k) repeating steps i) and k) to produce a multiplicity of tablets in a second batch from material of the second composition.

19. A method according to claim 18, wherein the tablet-pressing apparatus additionally comprises a material storage device.

20. A method according to claim 19, wherein the method comprises an additional step of removing and disposing of the material storage device or a lining in the material storage device, and then installing a new material storage device or lining.

21. A method according to claim 20, wherein the additional step occurs between step e) and step f).

22. A method according to claim 20, wherein the additional step is performed by disposing of the material storage device and replacing with a new material storage device.

23. A method according to claim 19, wherein material is passed from the material storage device to the die by means of a shoe which slides over the upper surface of the table.

24. A method according to claim 23, wherein between producing the first batch of tablets and producing the second batch of tablets, the shoe is replaced with a new shoe.

25. A method according to claim 18, wherein between producing the first batch of tablets and producing the second batch of tablets, the alignment of the table relative to the rest of the tablet-pressing apparatus is not adjusted.

26. A method according to claim 18, wherein between producing the first batch of tablets and producing the second batch of tablets, a cleanliness verification test is conducted on the tablet-pressing apparatus.

27. A tablet-pressing apparatus comprising:
i) a tablet-pressing table in which there is provided a die for containing material that is to be pressed into a tablet, and
ii) a punch for pressing material in the die to form a tablet, wherein
the table comprises a top plate which has an upper surface which encompasses all regions of contact, during use of the tablet-pressing apparatus to press tablets, between (a) the material that is pressed into tablets and the tablets once pressed from the material and (b) the top of the table, and
the top plate is removably mounted.

28. Apparatus according to claim 27, wherein the apparatus additionally comprises a material storage device for feeding material from which tablets may be pressed.

29. Apparatus according to claim 28, wherein the material storage device is made of plastics material.

30. Apparatus according to claim 27, wherein the table is made of metal.

31. Apparatus according to claim 27, wherein the top plate is made of metal.

32. Apparatus according to claim 27, wherein the top plate has a thickness of between 0.5 mm and 10 mm.

33. Apparatus according to claim 27, wherein the tablet-pressing apparatus is in the form of a single tablet press.

34. A tablet-pressing table having an aperture for receiving a tablet-pressing die, wherein the table comprises a removably mounted and disposable top plate and the table is suitable for use as the table of the tablet-pressing apparatus as claimed in claim 27.

35. Apparatus according to claim 29, wherein the table is made of metal and the top plate is made of metal.

36. Apparatus according to claim 31, wherein the top plate has a thickness of between 0.5 mm and 10 mm.
